(19) United States
(12) Patent Application Publication
(10) Pub. No.: US 2022/0048000 A1
(43) Pub. Date: Feb. 17, 2022

(54) DEVICE FOR CLEANING A TOOL, IN PARTICULAR A MIXER PROPELLER, AND ASSOCIATED METHOD

(71) Applicant: Jacques Jean Claude Nanguet, Canet d'Aude (FR)

(72) Inventor: Jacques Jean Claude Nanguet, Canet d'Aude (FR)

(21) Appl. No.: 17/276,069

(22) PCT Filed: Jul. 5, 2019
(86) PCT No.: PCT/IB2019/055754

§ 371 Date: Mar. 12, 2021

(30) Foreign Application Priority Data
Jul. 5, 2018 (FR) 18/00718

(51) Int. Cl. B01F 15/00; A46B 9/02

(52) U.S. Cl. CPC B01F 15/00045; A46B 2200/3006; A46B 9/028; B01F 15/00025

(57) ABSTRACT

A device and method for cleaning a tool, in particular a rotatable tool. The device includes a receptacle that has a longitudinal axis and contains at least one work portion of a tool that is to be cleaned; a plurality of brushing threads to be placed in the receptacle such that the threads are not parallel to the longitudinal axis, preferably extending at an angle or substantially perpendicularly to the longitudinal axis, with at least three thread support sections that support the brushing threads and are spaced angularly apart at regular intervals around the longitudinal axis.

### TECHNICAL FIELD

The present invention relates to the cleaning of tools, in particular those used in building construction work interallia. Particularly, the invention relates to a device for cleaning a tool, more particularly a tool capable of being driven in rotation, such as a mixer propeller. The invention further relates to a corresponding cleaning method.

### BACKGROUND

In the aforementioned field, it is common to use products which have to be dissolved and mixed, such as glue. Specific devices, known as mixers or kneaders, have therefore been provided, comprising a rotor, an arm and a propeller which, when rotating, makes it possible to mix the products necessary for the work. Propellers having complex shapes including convolutions are generally used.

As a result of these mixtures, product residues stick to the propeller and solidify.

If not cleaned early enough, removing solidified debris can cause damage, chipping or breakage, and premature tool wear.

It may be necessary to leave the propeller soaked in cleaning fluid for hours and manually brush the nooks and crannies of the propeller, typically for about 20 minutes. This results in product splashing on the user and considerable cleaning time.

A first objective of the invention is to provide a device allowing less tedious and faster cleaning than in the state of the art.

A second objective is to provide an efficient cleaning device.

A third objective is to provide a cleaning device which is hardly subject to deterioration in use.

### SUMMARY OF THE INVENTION

To achieve these objectives, the invention provides a device for cleaning a tool, in particular a tool capable of being driven in rotation, the device comprising
a container having a longitudinal axis, configured to contain at least a portion of a tool to be cleaned,
a plurality of brushing threads configured to be arranged, in the container, in a non-parallel manner to said longitudinal axis preferably of obliquely or substantially perpendicularly to said longitudinal axis.

According to a first aspect, the device comprises at least three thread support sections carrying said brushing threads, arranged angularly spaced evenly around said longitudinal axis.

Advantageously, the device according to the invention makes it possible to carry out quick and non-tedious cleaning by driving the working portion in rotation so that the brushing threads clean said working portion.

In addition, the arrangement of the angularly spaced threads evenly around the longitudinal axis improves cleaning efficiency by having several brushing zones distributed around the container.

According to other aspects taken alone or combined in all technically feasible combinations:
said working portion comprises a mixer propeller; and/or
the support sections are in one piece with the wall of the container and/or in one piece with the brushing threads; and/or
at least one support section comprises a plurality of threads anchored along said longitudinal axis; and/or
at least two longitudinally successive support sections are angularly offset; and/or
the support sections extend longitudinally along the height of the working portion to be cleaned, preferably over 15 to 30 cm, more preferably 20 cm; and/or
said brushing threads are made of polymer, preferably nylon, and preferably measure from 4 to 7 mm, more preferably from 5 to 6 mm; and/or
said brushing threads extend beyond the longitudinal axis; and/or
the cleaning device comprises a low support section placed substantially by the longitudinal axis and carrying low brushing threads oblique relative to the longitudinal axis or substantially parallel to the longitudinal axis; and/or
the low brushing threads have a smaller size than those of the other support sections, in particular 1 to 5 mm thick, preferably about 3 mm thick.

The invention further relates to a method for cleaning a tool characterized in that a working portion of the tool is immersed in a cleaning device according to the invention, comprising a cleaning liquid, and the tool is then driven in rotation so that the brushing threads contact and rub the working portion of the tool.

### BRIEF DESCRIPTION OF THE DRAWINGS

The invention will be further detailed by the description of non-limiting embodiments, and on the basis of the appended figures illustrating preferred embodiments of the invention, in which:

FIG. 1 is a top view in space of a device according to a first preferred embodiment of the invention;

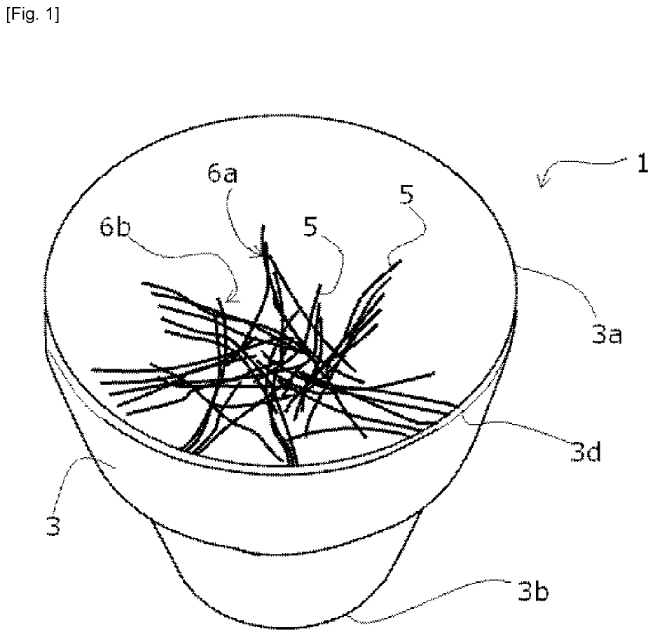

FIG. 2 is a simplified sectional view of a device according to a second preferred embodiment of the invention;

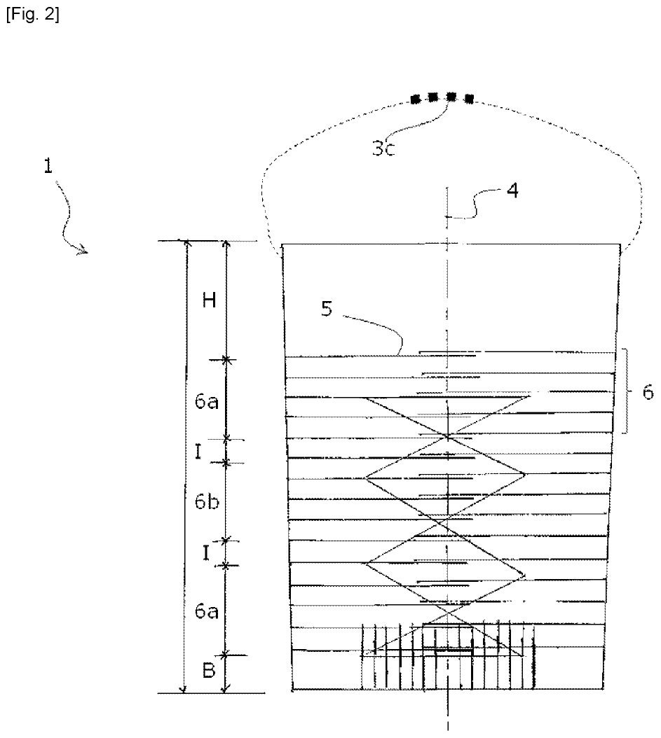

FIG. 3 is a simplified sectional view of a device according to a third preferred embodiment of the invention; and

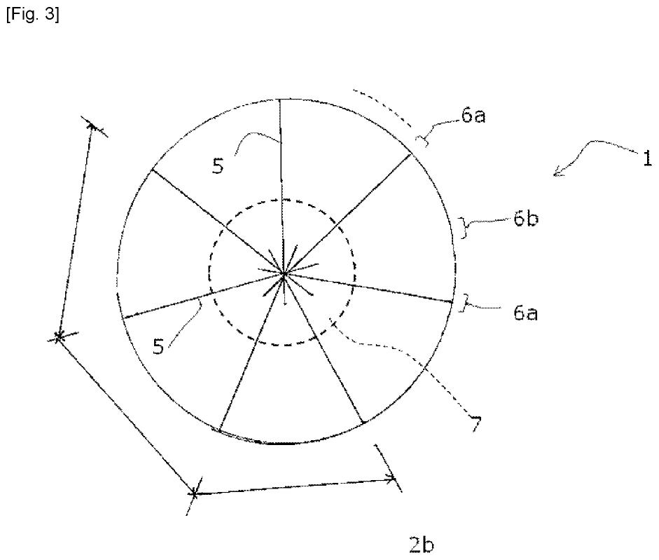

FIG. 4 is a simplified sectional view of the device of FIG. 3 in use with a mixer propeller.

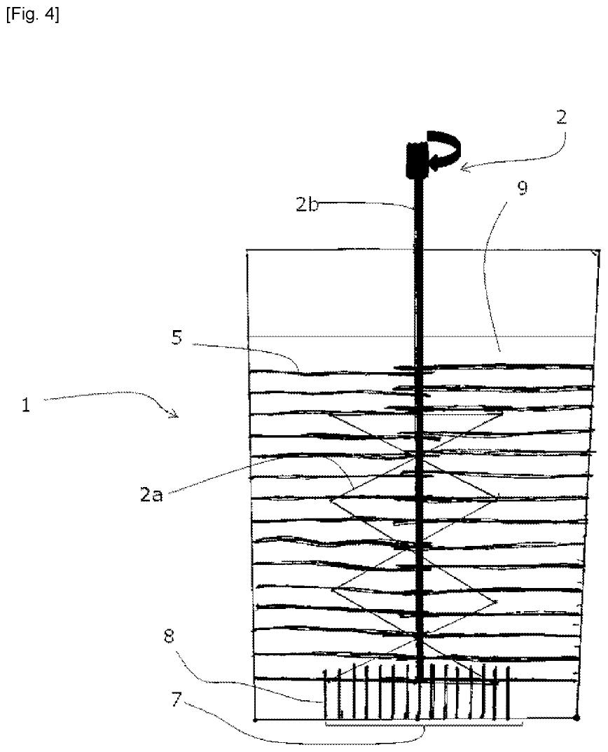

### DETAILED DESCRIPTION OF THE INVENTION

The invention relates to a cleaning device 1 of tool 2, such as those used in building construction work. The invention is particularly suitable for cleaning tool 2 capable of being driven in rotation. Tool 2 is in particular a mixer.

The device 1 according to the invention makes it possible to greatly improve the cleaning of tools capable of being driven in rotation, such as a propeller 2a of a mixer 2 comprising residues of sticky materials such as glue.

The cleaning device 1 comprises a container 3. The container 3 is chosen so as to be able to contain the portion of the tool 2 which is to be cleaned. This is in particular a working portion (2a) of a tool to be cleaned.

The container 3 has a longitudinal axis 4. The longitudinal axis 4 extends along the length of the container 3. The longitudinal axis 4 may be central to the container 3.

Preferably, the container 3 has a prismatic shape, more particularly a cylindrical shape; or a shape of a truncated cone. In both cases, the longitudinal axis 4 extends along the axis of revolution of the cylinder or the truncated cone.

In the illustrated embodiment, the container 3 measures 25 to 35 cm in width, for example an upper base diameter 3a of about 30 cm and a lower base diameter 3b of about 25 cm. In addition, the container is 35 to 40 cm in height, for example about 39 cm in height. It can be a bucket structure that can be fitted with a 3c handle.

The container 3 may have a corresponding cover (not shown) and a cover fixing structure 3d such as a clip element or a screw or bayonet system.

The device 1 further comprises a plurality of brushing threads 5. Advantageously, the brushing threads 5 make it possible to reach the areas that are difficult to access by the mixer propellers 2a, which makes it possible to clean these areas efficiently and quickly.

According to one embodiment, said brushing threads 5 are preferably substantially elastic polymer, more preferably nylon. Nylon threads make it possible to limit manufacturing costs because they are conventionally manufactured in large quantities to equip brush cutters. In addition, a polymer is little subject to deterioration, for example by oxidation.

In addition, according to an embodiment, the brushing threads 5 measure from 4 to 7 mm, more preferably from 5 to 6 mm thick. This size allows for satisfactory cleaning of its side sections of the mixer propellers 2a.

According to an embodiment, said brushing thread 5 extend radially beyond the longitudinal axis 4. In particular, the brushing thread 5 extend over 1 to 2 cm beyond the longitudinal axis 4. Advantageously, this embodiment makes it possible to effectively clean the central mast 2b of the propeller 2a of the mixer. In particular, the brushing threads 5 measure approximately 17 cm in the preferred embodiment.

The brushing threads 5 are configured to be arranged, in the container, in a non-parallel manner to said longitudinal axis 4, preferably obliquely or substantially perpendicular to said longitudinal axis 4. So that the brushing threads 5 come into contact with the surface to be cleaning, it is important that they are not oriented in a substantially parallel way to the longitudinal axis 4, in particular substantially vertical in use. Thus, an orientation at least partially oblique with reference to the longitudinal axis 4 is implemented to improve cleaning efficiency.

In particular, in use, the longitudinal axis 4 is preferably substantially vertical and the brushing threads 5 may be substantially oblique, more preferably at an angle of less than 30 degrees relative to the horizontal. Advantageously, such an angle makes it possible to significantly improve the efficiency of the brushing threads 5 because the threads cover more surface to be cleaned.

The fixing of the brushing threads 5 involves support sections 6, preferably at least by the side walls of the container 3. Thus, according to the invention, the device 1 comprises at least three thread support sections 6 carrying said threads. brushing 5. The support sections 6 are arranged in an evenly spaced angular manner around said longitudinal axis 4. This will be referred to as a radial arrangement.

Advantageously, the device 1 makes it possible to carry out a quick and not tedious cleaning by causing the propeller 2a to be driven in rotation so that the brushing threads 5 clean the propeller 2a.

In addition, the arrangement of the thread 5 angularly spaced evenly around the longitudinal axis 4 improves cleaning efficiency by having several brushing zones distributed around the container 3.

More preferably, the device comprises at least six, and preferably less than 10, thread support sections 6 carrying said brushing threads 5, arranged angularly spaced evenly around said longitudinal axis 4.

Beyond five support sections 6 in radial arrangement, there is better efficiency by good coverage of the element to be cleaned while having an alternation of brushing zones and empty zones for better dispersion of the cleaning debris. In the preferred embodiment, there are seven support sections 6. This corresponds to circular arc intervals of approximately 13.85 cm. This embodiment shows good results during the tests. In all likelihood, beyond ten support sections 6 the threads 5 begin to encumber each other and do not facilitate the dispersion of debris.

According to an embodiment, the support sections 6 are in one piece with the wall of the container 3. In particular, the wall forms a support for said threads 5 on corresponding sections. This embodiment makes it possible to improve the costs and manufacturing times compared to manufacturing a support that would then be welded or secured to the wall of the container 3.

According to an embodiment, the support sections 6 are in one piece with the brushing threads 5. It is possible to envisage using a fixing structure such as a head at one end of the brushing thread 5 to be secured to the container 5. This embodiment also makes it possible to improve the costs and manufacturing times compared to the manufacture of a support which would then be welded or secured to the brushing thread 5.

Preferably, the wall of the container 3, the brushing thread 5 and the support section 6 are all in one piece. It is for example possible to envisage making the device 1 with the brushing threads 5 in a single piece, for example in a single injection or in 3D printing.

According to an embodiment, at least one support section 6 comprises a plurality of threads 5 anchored along said longitudinal axis 4. The brushing threads 5 can be vertically spaced from 0.1 to 5 centimeters. In the preferred embodiment, the support sections 6 are spaced at an interval of 1 cm (Reference I) and the brushing threads 5 of a support section 6 extend over 6 cm. This embodiment shows good results during the tests. We will refer to it as a longitudinal or vertical arrangement. In particular, it is possible to define a support section 6 with five anchors for brushing threads 5.

According to an embodiment, at least two longitudinally successive support sections 6a, 6b that are angularly offset. The two sections 6a, 6b are successive in the longitudinal arrangement, but in the radial arrangement they are radially offset. Preferably, the next support section is also offset in the same way but aligned with the first support section, and so on. Advantageously, this arrangement makes it possible to alternate the brushing zones and the empty zones longitudinally for better dispersion of the cleaning debris.

Alternatively, all of the support sections 6 extend longitudinally along the height of the working portion to be cleaned. Preferably, all of the support sections extend longitudinally over 15 to 30 cm in height, more preferably about 20 cm. This corresponds to the propellers 2a generally used.

Preferably, the lower support sections 6 extend approximately 1 to 7 cm, more preferably 2 cm, from the bottom of the container 3 (Reference B). Advantageously, this makes it possible to cover the lateral distal part of the propeller 2, while leaving it to rest near the bottom.

Further, preferably, the uppermost support sections 6 extend approximately 10 to 25 cm, more preferably 17 cm, from the top of container 3 (Reference H). Advantageously, this makes it possible to limit the losses of cleaning liquid.

According to an embodiment, the device 1 comprises a low support section 7 preferably placed substantially by the longitudinal axis 4. The low support section 7 carries low brushing threads 8 oblique with respect to the longitudinal axis 4 or substantially parallel to the longitudinal axis 4.

It is conceivable that the lower support section 7 is slightly offset in the horizontal direction relative to the longitudinal axis 4.

The low support section 7 and the corresponding low brushing threads 8 effectively clean the distal end of the mixer propeller 2a. Cleaning efficiency depends on at least an oblique orientation. Good efficiency is obtained with parallel orientation, especially vertical in use.

The low brushing threads 8 may have one or more of the characteristics of the brushing threads 5.

We may refer to lateral support sections 5 for the other support sections which enable to clean the lateral parts of the propeller 2a of the mixer.

According to an embodiment, the low brushing threads 8 of the low support section 8 have a smaller size than those of the other support sections 5. In particular, the low brushing threads 8 measure from 1 to 5 mm, preferably approximately 3 mm. mm thick.

According to an embodiment, the low brushing threads 8 of the low support section 7 have a length of 2 to 6 cm, preferably about 4 cm.

The low brushing threads 8 are configured and arranged so that a propeller can rest on them without touching the bottom of the container. This makes it possible to limit the efforts to hold the propeller-rotor assembly during cleaning.

The invention further relates to a corresponding cleaning method. The method makes it possible to clean, by means of a device 1 as described above, a working portion of a tool 2, in particular a mixer propeller 2a.

First, the container is filled with liquid 9 which will be used for cleaning. It can be pure water or not, or a mixture of solvent, optionally with a cleaning product.

The portion (2a) to be cleaned is immersed in the liquid 9 in the container 3, so that the brushing threads 5 are distributed all around the section to be cleaned. Preferably, the low brushing threads 8 are distributed around the distal end of the portion to be cleaned.

Tool 2, or portion 2a, is then driven in rotation. A standard speed of rotation, for example 150 revolutions per minute is sufficient for a good cleaning.

While the tool 2, or the portion 2a, is rotating, the brushing threads 5 contact and rub the working portion 2a of the tool and remove debris therefrom. Preferably, the low brushing threads 8 come into contact and rub the distal end of the portion 2a to be cleaned.

Advantageously, the method makes it possible to have effective cleaning without effort on the part of the user by limiting the splashing of products thereon as well as the cleaning time.

Tool 2 can thus be preserved and used for longer without being prematurely chipped or broken.

One can envision a version where the brushing threads and the support section (s) are rotated in a fixed container, to clean a fixed tool. Likewise, such an alternative device and method allows efficient cleaning without user effort by limiting product splashing thereon as well as the cleaning time.

The invention finds its application for cleaning all types of potentially tedious tools whose cleaning proves to be tedious in particular because of sticky elements on the tool, such as mixers in the kitchen and bakery industry.

What is claimed is:

1. A device for cleaning a tool capable of being driven in rotation, the device comprising:
a container having a longitudinal axis configured to contain at least a portion of a tool to be cleaned,
a plurality of brushing threads configured to be arranged in the container in a non-parallel manner to said longitudinal axis, wherein the device comprises:
at least three thread support sections carrying said brushing threads arranged angularly spaced evenly around said longitudinal axis.

2. The device of claim 1, wherein said working portion comprises a mixer propeller.

3. The device of claim 1, wherein the support sections are in one piece with the wall of the container and/or in one piece with the brushing threads.

4. The device of claim 3, wherein the support sections are in one piece with the wall of the container and in one piece with the brushing threads.

5. The device of claim 1, wherein at least one support section comprises a plurality of threads anchored along said longitudinal axis.

6. The device of claim 5, wherein at least two longitudinally successive support sections are angularly offset.

7. The device of claim 6, wherein the support sections are arranged so as to alternate longitudinally brushing zones and empty zones.

8. The device of claim 1, wherein the support sections extend longitudinally along the height of the working portion to be cleaned, and over 15 to 30 cm.

9. The device of claim 1, wherein said brushing threads are made of polymer.

10. The device of claim 9, wherein said brushing threads are made of nylon.

11. The device of claim 1, wherein said brushing threads measure from 4 to 7 mm.

12. The device of claim 1, wherein said brushing threads extend beyond the longitudinal axis.

13. The device of claim 1, comprising a low support section placed substantially by the longitudinal axis and carrying low brushing threads oblique with respect to the longitudinal axis or substantially parallel to the longitudinal axis.

14. The device of claim 1, wherein the low brushing threads have a smaller size than those of the other support sections, and a thickness of 1 to 5 mm thick.

15. The device of claim 1, wherein the brushing threads are configured to be arranged in the container obliquely or substantially perpendicularly to said longitudinal axis.

16. A method for cleaning a tool capable of being driven in rotation with a device for cleaning comprising a container having a longitudinal axis and configured to contain at least a portion of a tool to be cleaned, a plurality of brushing threads configured to be arranged in the container in a non-parallel manner to said longitudinal axis, at least three thread support sections carrying said brushing threads arranged angularly spaced evenly around said longitudinal axis, wherein the method comprises:
immersing a working portion of the tool in the device for cleaning, wherein the device for cleaning comprises a cleaning liquid; and
driving the tool in rotation so that the brushing threads come into contact and rub the working portion of the tool.
